(19) United States
(12) Patent Application Publication
(10) Pub. No.: US 2007/0085928 A1
(43) Pub. Date: Apr. 19, 2007

(54) Method of video image processing

(75) Inventor: Jeroen Aloysius Hendrikus Maria Sloot, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/579,151

(22) PCT Filed: Nov. 2, 2004
(86) PCT No.: PCT/IB04/52261

§ 371 Date: May 12, 2006

(30) Foreign Application Priority Data
Nov. 17, 2003 (EP) 03104234.4

(51) Int. Cl. H04N 7/12

(52) U.S. Cl. 348/468; 375/240.26

(57) ABSTRACT

A method of video image processing comprises receiving a video signal (5,6) carrying input information representing moving images occupying an area (12) of display, processing the received input information and generating an output video signal (10,11) carrying output information representing moving images occupying the area (12) of display. It is characterised by re-scaling a section of the moving images represented by the input information occupying a selected section (17,18) of the area (12) of display independently of parts (14) of the moving images occupying the remainder of the area (12) of display.

The invention relates to a method of video image processing, comprising: receiving a video signal carrying input information representing moving images occupying an area of display, and processing the received input information and generating an output video signal carrying output information representing moving images occupying the area of display.

The invention further relates to video image processing system, specially adapted for carrying out such a method.

The invention also relates to a display device, e.g. a television set, specially adapted for carrying out such a method.

The invention also relates to a computer program product.

Examples of a method and image processing system of the types mentioned above are known from the abstract of JP 2002-044590. This publication concerns a DVD (Digital Versatile Disc) video reproducing device that can display captions on a small-sized display device in the case of displaying a reproduction video image of a DVD video. A user sets a caption magnification rate and a caption colour to be stored into a user caption setting memory prior to reproduction of a DVD video. When a sub-picture display instruction is received, a sub-picture display area read from a disk is magnified by the magnification rate stored in the user caption setting memory. The sub-picture video image is generated in colour stored in the user caption setting memory and given to a compositor. The compositor composites a main video image received from a video decoder with a sub-video image received from a sub-video image decoder and provides an output.

A problem of the known device is that it relies on the caption information being separately available as a sub picture video image to be read from a disk and subsequently combined with the moving images by the compositor.

It is an object of the invention to provide an alternative method of image video processing, usable amongst others, to increase the legibility of captions included in the input information.

This object is achieved by the method according to the invention, which is characterised by re-scaling a section of the moving images represented by the input information occupying a selected section of the area of display independently of parts of the moving images occupying the remainder of the area of display.

Thus, it is possible to enhance the legibility of captions occupying the selected section of the area of display, thereby increasing the legibility. Of course, the invention can equally be used to view other parts of the moving images not readily discernible, for example a nameplate appearing in a video of a person walking along a street.

It is observed that ‘picture zooming’ is a feature commonly provided on television sets. However, this entails the magnification of the entire moving image. By contrast, the invention comprises the re-scaling of a section of the moving images, independently of the remainder of the moving images, which remainder may be left at its original size.

A preferred embodiment comprises including in the output information as much of the information representing the re-scaled section of the moving image as represents a largest part of the re-scaled section of the moving image that would fit substantially within the selected section of the area of display.

Thus, when the re-scaling is a magnification, the re-scaled section does not lead to more information being carried in the output video signal than in the input video signal.

Preferably, this embodiment of the method comprises generating the output information in such a way that the represented largest part is positioned over the selected section of the area of display.

Thus, an enlarged section will not obscure other parts of the moving images. It is thus possible to enlarge only captions in moving images, whilst leaving the remainder of the moving images at the original size. There is thus no distortion of those remaining parts, but the captions become more legible.

A preferred embodiment of the invention comprises analysing the input information for the presence of pre-defined image elements and defining the selected section to encompass at least some of the image elements found to be present.

Thus, the viewer need not define the selected area himself. Instead, the pre-defined image elements determine the size and position of the area of the moving images to be selected for re-scaling.

In a preferred variant of this embodiment, the pre-defined image elements comprise text, e.g. closed caption text.

Thus, this variant comprises the automatic definition of a section of the total area of display, which is to be re-scaled, such that it encompasses text which is illegible due to its size.

In a preferred embodiment, the received video signal is a component video signal.

This implies that the signal is in a format such as may be generated by a video decoder in a television set, for example. This embodiment has the advantage that it does not require elaborate graphics processing and conversion of data into different formats. Rather, it can be added as a feature to a standard digital signal processing stage in between the video decoder and video output processor of a television set.

According to another aspect of the invention, the video image processing system according to the invention is specially adapted for carrying out a method according to the invention.

According to another aspect of the invention, the display device, e.g. a television set, according to the invention is specially adapted for carrying out a method according to the invention.

According to a further aspect of the invention, the computer program product according to the invention comprises means, when run on a programmable data processing device, of enabling the programmable data processing device to carry out a method according to the invention.

The invention will now be explained in further detail with reference to the accompanying drawings, in which:

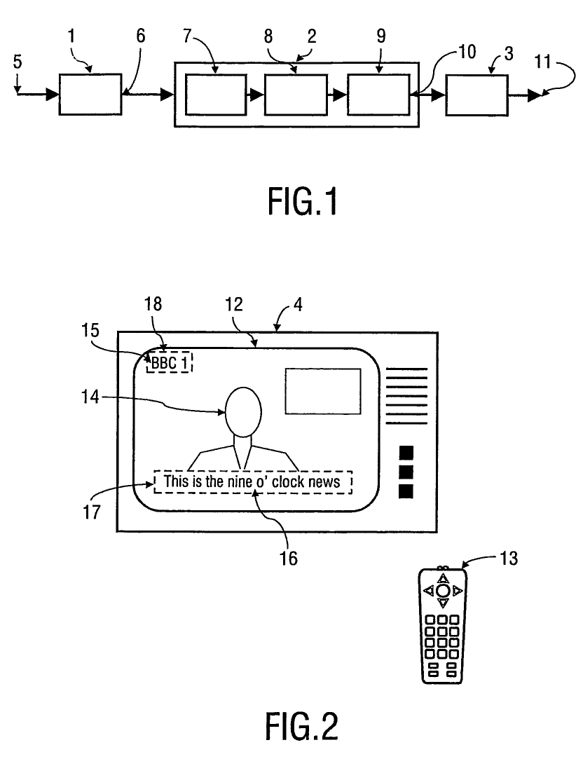

FIG. 1 shows a common video signal path, suitable for adaptation to the invention; and

FIG. 2 is a front view of a television set in which the invention has been implemented.

A method is provided that is carried out within a video image-processing device contained in a video signal path. An example of the video signal path is shown in FIG. 1. The video signal path is an abstract schematic. It may be implemented in one or more discrete signal processing devices. In the illustrated example, there are three components, namely a video decoder 1, a video features processor 2, and a video output processor 3. An alternative may be so-called system-on-a-chip. The video signal path is contained, for example in a television set 4 (see FIG. 2). Alternative video image processing systems in which the invention may be implemented include video monitors, videocassette recorders, DVD-players and set-top boxes.

Returning to FIG. 1, the video decoder 1 receives a composite video signal 5 from an IF stage or baseband input like SCART. The video decoder 1 will detect the signal properties like PAL, NTSC, and convert the signal into a more manageable component video signal 6. This signal may be an RGB, YPbPr or YUV representation of a series of moving images. In the following, a YUV representation will be assumed.

Further video featuring will be performed on the component video signal 6 in the video features processor 2. The video featuring is divided into front-end feature processes 7, memory based feature processes 8 and back-end feature processes 9. The invention is preferably implemented as one of the memory based feature processes 8.

The video features processor 2 generates an output signal 10 that is preferably also a component video signal, preferably in the YUV format. This output signal is provided to the video output processor 3, which converts the video output signal 10 into a format for driving a display. For example, the video output processor 3 will generate an RGB signal 11, which drives the electron beams of a television tube that creates a visible picture in an area of display of a screen 12 of the television set 4 (FIG. 2).

The television set 4 comes with a remote control unit 13, with which user commands can be provided to the television set 4, for example to control the type and extent of video feature processing by the video features processor 2. In the example of FIG. 2, there are present within the area of display a newsreader 14, a network logo 15 and closed caption text 16. The closed caption text 16 may have been provided as standard in the information contained in the composite and component video signals 5,6. Alternatively, it may have been added by a teletext decoder and presentation module, comprised in the front-end feature processes 7 or memory based feature processes 8. In that case, the invention operates on a signal carrying information including the caption text 16 overlaid on the other information representing the newsreader 14, the network logo 15 and all other parts of the moving images by the teletext decoder and presentation module.

The invention provides a zoom function that zooms in on the section of the area of display where the caption text 16 is located without zooming in on the full area of display. In principle, it can also be used to zoom in on another part of the screen 12, for example the network logo 15. Once the selected section and scaling factor have been set, the selected section is automatically re-scaled over a number of frames in a series of moving image frames by operating directly on information representing that series of moving image frames and carried by a video input signal.

In one variant, the information carried in the video signal on which the feature operates is analysed for the presence of pre-defined image elements, such as text of a certain size and lettering corresponding to that of the closed caption text 16. In one variant of the invention, a selected area 17 is automatically identified by the video features processor 2, which carries out the analysis. To implement this variant, reference may be had to WO 02/093910, entitled ‘Detecting subtitles in a video signal’, filed by the present applicant. This publication discloses several techniques for detecting the presence of closed caption texts in the video signal. By means of these techniques, the area in which they are present can be determined.

Once the selected area 17 has been defined, the section of the area of display corresponding to the selected area 17 is scaled in accordance with control information provided through a user input module, e.g. the remote control unit 13. Of course, the control information may also be provided through keys on the television set 4.

In most cases, the control information will comprise an enlargement factor. The video features processor 2 enlarges the section of the moving images represented by the input information it operates on that occupies the selected area 17 of the total area of display. Enlargement of this section is done independently of the parts of the moving images occupying the remainder of the total area of display. Thus, the parts of the moving images originally defined to be displayed within the selected area 17 (i.e. the closed caption text 16 and any background thereto) are enlarged, whereas the remainder (including the newsreader 14 and network logo 15) remains at the size defined by the input information.

In the case of enlargement, the enlarged part of the moving images is cropped to be able to fit substantially within the selected area 17 of the total area of display. Only information representing the cropped enlarged section is included in the output information that is provided as input to the background feature processes 9. Preferably the information representing the cropped enlarged part of the moving images is also inserted into the output information in such a way that the represented part is positioned substantially over the selected area 17. In this way, the remainder of the moving images is not affected in any way by the re-sizing.

Alternatively, the size and position of the selected area 17 may also be set by the user. In that case, the remote control unit 13 or other type of user input module is used to provide control information defining the size and position of the selected area 17 to the video features processor 2.

A combination of automatic and user-defined definition of the section of the moving images to be re-sized is also possible. For example, the selected area 17 may be automatically defined on the basis of recognised closed captions text 16, whereas a user-defined selected area 18 may be used to zoom in on sections like the network logo 15 elsewhere on the screen. Selected sections are re-sized independently of the remainder of the area of display.

A number of possibilities exist for implementing the re-scaling. A first technique is deflection based, and specifically intended for implementation in a video output processor 3 providing a signal to the electron beams of a cathode ray tube (CRT). This implementation has the advantage of making use of existing picture alignment features. A second technique makes use of line-based video processing, using digital zoom options and a line memory. It is thus implemented as part of the memory based feature processes 8. In this case, a range of lines, corresponding to the selected area 17, in each of the series of consecutive frames of the moving images is stored and enlarged. The information for the enlarged lines replaces that for the originally received lines. A third, and most accurate and flexible, technique, makes use of field video memory and digital interpolation in each field. Although requiring some additional processing capacity, it has the advantage of accuracy and flexibility. For example, many different types of digital interpolation can be used. This variant is also more flexible in terms of the size and shape of the selected areas 17, 18 that can be employed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage. For instance, other means than those based on graphical user interfaces or automatic caption text recognition may be used to determine the section of the area of display to be re-sized.

1. Method of video image processing, comprising receiving a video signal (5,6) carrying input information representing moving images occupying an area (12) of display, processing the received input information and generating an output video signal (10,11) carrying output information representing moving images occupying the area (12) of display, characterised by, re-scaling a section of the moving images represented by the input information occupying a selected section (17,18) of the area (12) of display independently of parts (14) of the moving images occupying the remainder of the area (12) of display.

2. Method according to claim 1, comprising including in the output information as much of the information representing the re-scaled section of the moving image as represents a largest part of the re-scaled section of the moving image that would fit substantially within the selected section (17,18) of the area (12) of display.

3. Method according to claim 2, comprising generating the output information in such a way that the represented largest part is positioned over the selected section (17,18) of the area (12) of display.

4. Method according to any one of the preceding claims, comprising analysing the input information for the presence of pre-defined image elements (16) and defining the selected section (17) to encompass at least some of the image elements (16) found to be present.

5. Method according to claim 4, wherein the pre-defined image elements (16) comprise text, e.g. closed caption text.

6. Method according to any one of the preceding claims, wherein the received video signal (6) is a component video signal.

7. Video image processing system, specially adapted for carrying out a method according to any one of claims 1-6.

8. Display device, e.g. a television set (4), specially adapted for carrying out a method according to any one of claims 1-6.

9. Computer program product, comprising means, when run on a programmable data processing device (2), of enabling the programmable data processing device (2) to carry out a method according to any one of claims 1-6.
